(19) United States
(12) Patent Application Publication
(10) Pub. No.: US 2013/0130002 A1
(43) Pub. Date: May 23, 2013

(54) WINDOW PANEL FOR DISPLAY DEVICE AND DISPLAY DEVICE INCLUDING THE WINDOW PANEL

(71) Applicants: Kyu-Taek Lee, Yongin-city (KR); Kwan-Young Han, Yongin-city (KR)

(72) Inventors: Kyu-Taek Lee, Yongin-city (KR); Kwan-Young Han, Yongin-city (KR)

(21) Appl. No.: 13/540,546

(22) Filed: Jul. 2, 2012

(30) Foreign Application Priority Data
Nov. 18, 2011 (KR) 10-2011-0120994

(51) Int. Cl. B32B 7/02; B32B 5/00; B32B 27/30; B32B 9/04; B32B 27/38

(52) U.S. Cl. 428/216; 428/411.1; 428/413; 428/523; 428/336

(57) ABSTRACT

A window panel for a display device including a plastic substrate, and a hard coating layer formed on at least one side of the plastic substrate and including at least two continuously deposited layers. Here, a display device includes the window panel.

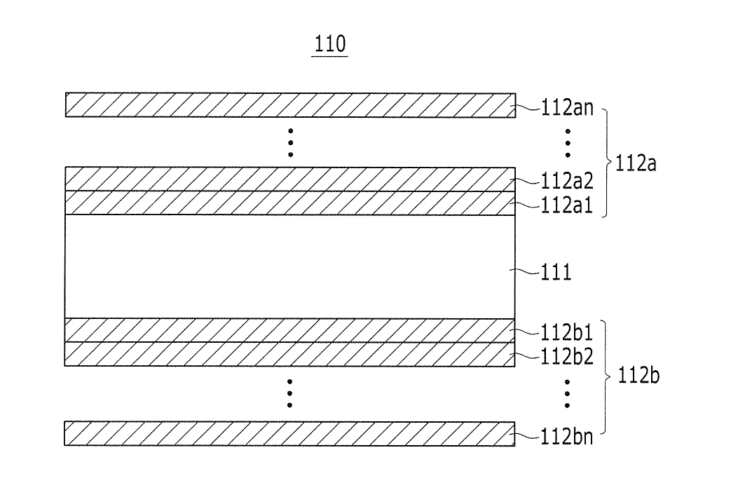

### CROSS-REFERENCE TO RELATED APPLICATION

This application claims priority to and the benefit of Korean Patent Application No. 10-2011-0120994, filed in the Korean Intellectual Property Office on Nov. 18, 2011, the entire content of which is incorporated herein by reference.

### BACKGROUND

1. Field

A window panel for a display device and a display device including the same are disclosed.

2. Description of Related Art

Currently, known display devices include a liquid crystal display (LCD), a plasma display panel (PDP), an organic light emitting diode display (OLED), a field effect display (FED), an electrophoretic display device, and the like. Such a display device includes a display module displaying image and a window panel protecting the display module. Glass may be used as the window panel.

However, since glass may be easily broken by external impact, a portable device (such as a mobile phone) formed with such a glass window panel may be easily damaged. Therefore, recently, a window panel made of plastic material instead of glass is being researched.

However, as a display device having a touch screen function is used, fingers or a sharp tool such as a pen may frequently contact on one side of the window panel. In this case, scratch may be easily generated at the surface of a window panel made of plastic.

### SUMMARY

An aspect of an embodiment of the present invention is directed toward a window panel capable of reducing surface scratch while maintaining impact resistance.

Another aspect of an embodiment of the present invention is directed toward a display device including the window panel.

According to one embodiment, there is provided a window panel for a display device including a plastic substrate, and a hard coating layer formed on at least one side of the plastic substrate and having at least two continuously deposited layers.

The at least two continuously deposited layers of the hard coating layer may have at least two layers each including the same material.

The hard coating layer may include an acryl-based compound, an epoxy-based compound, an organic/inorganic composite compound or a combination thereof.

Each hard coating layer may have a thickness of about 10 to about 20 μm.

The at least two continuously deposited layers of the hard coating layer may have at least two layers each including a different material.

The at least two layers of the hard coating layer may include a first layer including an acryl-based compound, an epoxy-based compound or a combination thereof, and a second layer including an organic/inorganic composite compound.

The first layer may have a thickness of about 5 to about 30 μm, and the second layer may have a thickness of about 5 to about 30 μm.

The at least two layers of the hard coating layer may include a first layer and a second layer, the first layer being positioned between the plastic substrate and the second layer, and the second layer having a higher surface hardness than that of the first layer. In one embodiment, the second layer is a top (topmost) layer of the hard coating layer.

The at least tow continuously deposited layers of the hard coating layer may include two to five layers.

The hard coating layer may have surface hardness of about 6H to 8H.

The hard coating layer may have impact resistance of at least about 20 cm, by a Ball Drop measuring device which drops a weight of about 130 g.

According to another embodiment, provided is a display device including the above described window panel for a display device.

### BRIEF DESCRIPTION OF THE DRAWING

The drawing is a cross-sectional view of a window panel for a display device according to one embodiment.

### DETAILED DESCRIPTION

The present disclosure will be described more fully hereinafter with reference to the accompanying drawings, in which exemplary embodiments of this disclosure are shown. This disclosure may, however, be embodied in many different forms and is not construed as limited to the exemplary embodiments set forth herein.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Referring to the drawing, a window panel for a display device will be described in accordance with an embodiment of this disclosure.

Here, the provided drawing is a cross-sectional view of a window panel for a display device according to one embodiment.

The window panel for the display device according to the one embodiment includes a plastic substrate 111, a hard coating layer 112a formed on one side of the plastic substrate 111, and a hard coating layer 112b formed on the other side of the plastic substrate 111.

The plastic substrate 111 may be made of a polymer compound, for example polyimide, polyacrylate, polyethyleneetherphthalate, polyethylene naphthalate, polycarbonate, polyarylate, polyetherimide, polyethersulfone, polymethyl(meth)acrylate, cellulose triacetate, polyvinylidene chloride, polyvinylidene fluoride, an ethylene-vinylalcohol copolymer, or a combination thereof.

The hard coating layers 112a and 112b respectively include at least two continuously deposited layers (112a1, 112a2, . . . , 112an, 112b1, 112b2, . . . , 112bn).

One of the hard coating layers 112a and 112b may be omitted.

Each layer (112a1, 112a2, . . . , 112an, 112b1, 112b2, . . . , 112bn) constituting the hard coating layers 112a and 112b may be made of the same material. For example, each layer constituting the hard coating layers 112a and 112b may be made of an organic compound or an organic/inorganic composite compound, wherein the organic compound may include an acryl-based compound, an epoxy-based compound or a combination thereof, and the organic/inorganic composite compound may include a silicon compound such as polysilsesquioxane.

Each layer (112a1, 112a2, . . . , 112an, 112b1, 112b2, . . . , 112bn) constituting the hard coating layers 112a and 112b may have a thickness of about 10 to about 20 μm. In one embodiment, as each layer has a thickness of the above range, high surface hardness of each of the hard coating layers 112a and 112b can be realized without generating bending.

Each layer (112a1, 112a2, 112an, 112b1, 112b2, . . . , 112bn) constituting the hard coating layers 112a and 112b may be made of different material. For example, a part of the hard coating layers 112a and 112b may be made of an organic compound such as an acryl-based compound, an epoxy-based compound or a combination thereof, and the other part of the hard coating layers 112a and 112b may be made of an organic/inorganic composite compound such as polysilsesquioxane. At this time, the layers made of different materials may be alternatively deposited.

Each layer (112a1, 112a2, . . . , 112an, 112b1, 112b2, . . . , 112bn) constituting the hard coating layers 112a and 112b made of an organic compound (such as an acryl-based compound, an epoxy-based compound or a combination thereof) may have a thickness of about 5 to about 30 μm, and each layer (112a1, 112a2, . . . , 112an, 112b1, 112b2, . . . , 112bn) constituting the hard coating layers 112a and 112b made of an organic/inorganic composite compound (such as polysilsesquioxane) may have a thickness of about 5 to about 30 μm. In one embodiment, as each layer has a thickness of the above range, the hard coating layers 112a and 112b may exhibit high surface hardness without generating bending.

In the hard coating layers 112a and 112b, the stacking structure of at least one layer positioned between the plastic substrate 111 and the top layer may have different surface hardness than the top layer (e.g., layer 112an or 112bn), and the surface hardness of the top layer may be higher than the surface hardness of the stacking structure of at least one layer positioned thereunder.

The surface hardness of the hard coating layers 112a and 112b including at least two layers may be higher than the surface hardness of each layer constituting the hard coating layers 112a and 112b.

For example, the hard coating layers 112a and 112b may have surface hardness of 6H or higher, particularly 6H to 8H. Meanwhile, each layer constituting the hard coating layers 112a and 112b may have surface hardness of 4H to 6H. Wherein, the surface hardness is the result of measuring under 1 kg load using a pencil hardness tester (manufacturer: BMS Tech).

The hard coating layers 112a and 112b may respectively include two to five continuously deposited layers.

The hard coating layers 112a and 112b may have impact resistance of at least about 20 cm, by a Ball Drop measuring device which drops a weight of about 130 g.

Here, the relationship between the surface hardness and the impact resistance may be a trade-off relationship. That is, if surface hardness is high, impact resistance is low, and if impact resistance is high, surface hardness is low.

The window panel for a display device 100 according to the embodiment of the invention may simultaneously satisfy surface hardness and impact resistance, by including the hard coating layers 112a and 112b positioned on at least one side of the plastic substrate 111 and having at least two continuously deposited layers.

The above explained window panel may be applied for various display devices.

The window panel may be disposed on a display module, wherein the display module may include a liquid crystal display module, an organic light emitting display module, a plasma display module, an electric field effect display module, an electrophoresis display module, and the like.

The following examples illustrate the present invention in more detail. These examples, however, are not in any sense to be interpreted as limiting the scope of this disclosure.

### Formation of Window Panel

### Example 1

A polymethylmethacrylate (PMMA) substrate was dipped in and coated therewith a polymer solution formed of a mixture of an acrylic resin, an epoxy resin and methyl ethyl ketone (MEK), and then, dried.

The coating and drying process was additionally repeated four times to form a hard coating layer having a total of five layers.

### Example 2

A polymethylmethacrylate (PMMA) substrate was dipped in a polymer solution formed of a mixture of an acrylic resin, an epoxy resin and methyl ethyl ketone, and dried to form a hard coating layer having one layer.

Subsequently, the substrate was dipped in a polysilsesquioxane solution, and dried to form a hard coating layer having two layers.

### Example 3

A polymethylmethacrylate (PMMA) substrate was dipped in a polymer solution formed of a mixture of an acrylic resin, an epoxy resin and methyl ethyl ketone, and dried to form a hard coating layer having one layer.

Subsequently, the substrate on which the hard coating layer of one layer is formed was dipped in a polysilsesquioxane solution, and dried to form a hard coating layer having two layers.

Subsequently, the substrate on which the hard coating layer having the two layers is formed was dipped in a polymer solution, and dried to form a hard coating layer having three layers.

### Comparative Example 1

A polymethylmethacrylate (PMMA) substrate was dipped in a polymer solution formed of a mixture of an acrylic resin, an epoxy resin and methyl ethyl ketone, and dried to form a hard coating layer having a single layer with a thickness of about 5 μm.

### Comparative Example 2

A polymethylmethacrylate (PMMA) substrate was dipped in a polymer solution mixing an acrylic resin, an epoxy resin and methyl ethyl ketone (MEK), and dried to form a hard coating layer having a single layer with a thickness of about 10 μm.

### Comparative Example 3

A polymethylmethacrylate (PMMA) substrate was dipped in a polysilsesquioxane solution, and dried to form a hard coating layer having a single layer with a thickness of about 10 μm.

### Measure of Surface Hardness—1

Surface hardnesses of the window panels of Example 1 and Comparative Examples 1 and 2 were measured under 1 kg load using a pencil hardness tester (manufacturer: BMS Tech).

The thickness and the surface hardness of the hard coating layer are described in Table 1.

TABLE 1

| | | | Surface Hardness |
|---|---|---|---|
| | Coating (times) | Thickness (μm) | (H) |
| Example 1 | 1 | 12.3 | 5 |
| | 2 | 17.2 | 6 |
| | 3 | 19.5 | 6 |
| | 4 | 19.3 | 6 |
| | 5 | 17.1 | 7 |
| Comparative | 1 | 5 | 4 |
| Example 1 | | | |
| Comparative | 1 | 10 | 5 |
| Example 2 | | | |

Referring to Table 1, it may be seen that the window panels according to Example 1 wherein two or more layers are deposited have surface hardness of 6H to 7H, while the window panels according to Comparative Examples 1 and 2 respectively have surface hardness of 4H and 5H. Thus, it is confirmed that if a hard coating layer having two or more deposited layers is applied, surface hardness may be improved compared to the case wherein a hard coating layer of a single layer is applied.

### Measure of Surface Hardness—2

Surface hardnesses of the window panels according to Examples 2 and 3 and Comparative Examples 2 and 3 were measured.

The results are described in Table 2.

TABLE 2

| | Thickness (μm) | Surface Hardness (H) |
|---|---|---|
| Example 2 | 19.1 | 7 |
| Example 3 | 27.9 | 7 |
| Comparative Example 2 | 10 | 5 |
| Comparative Example 3 | 10 | 5 |

Referring to Table 2, it may be seen that the surface hardness of the window panels according to Examples 2 and 3 is 7H, while the surface hardness of the window panels according to Comparative Examples 2 and 3 is 5H. Thus, it is confirmed that if a hard coating layer having two or more deposited layers is applied, surface hardness is improved compared to the case wherein a hard coating layer of a single layer is applied.

### Measure of Impact Resistance

Using a Ball Drop measuring device which drops a weight of 130 g on the center of the window panels according to Examples 1 to 3, impact resistance was measured.

As the result, it is confirmed that all window panels according to Examples 1 to 3 and Comparative Examples 1 to 3 were not broken, even at a height of 20 cm or more.

Thus, it is may be seen that the window panels according to Examples 1 to 3 have impact resistance equal to the window panels according to Comparative Examples 1 to 3.

As explained, it may be seen that the window panels according to Examples 1 to 3 have improved surface hardness while maintaining impact resistance equal to the window panels according to Comparative Examples 1 to 3. Therefore, the window panels according to Examples 1 to 3 may satisfy both impact resistance and surface hardness having the trade-off relationship, thus improving surface scratch resistance characteristics without reducing external impact resistance characteristics.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A window panel for a display device comprising
a plastic substrate, and
a hard coating layer on a side of the plastic substrate, the hard coating layer comprising at least two continuously deposited layers.

2. The window panel for a display device of claim 1, wherein the at least two continuously deposited layers of the hard coating layer comprise at least two layers each including the same material.

3. The window panel for a display device of claim 2, wherein the hard coating layer comprises an acryl-based compound, an epoxy-based compound, an organic/inorganic composite compound or a combination thereof.

4. The window panel for a display device of claim 2, wherein the hard coating layer has a thickness of about 10 to about 20 μm.

5. The window panel for a display device of claim 1, wherein the at least two continuously deposited layers of the hard coating layer comprise at least two layers each including a different material.

6. The window panel for a display device of claim 5, wherein the at least two layers comprise a first layer including an acryl-based compound, an epoxy-based compound or a combination thereof, and
a second layer including an organic/inorganic composite compound.

7. The window panel for a display device of claim 6, wherein the first layer has a thickness of about 5 to about 30 μm, and
the second layer has a thickness of about 5 to about 30 μm.

8. The window panel for a display device of claim 5, wherein the at least two layers comprise a first layer and a second layer, the first layer being positioned between the plastic substrate and the second layer, and the second layer having a higher surface hardness than that of the first layer.

9. The window panel for a display device of claim 8, wherein the second layer is a top layer of the hard coating layer.

10. The window panel for a display device of claim 1, wherein the at least two continuously deposited layers of the hard coating layer comprise two to five layers.

11. The window panel for a display device of claim 1, wherein the hard coating layer has surface hardness of about 6H to 8H.

12. The window panel for a display device of claim 1, wherein the hard coating layer has impact resistance of at least about 20 cm, as measured using a Ball Drop measuring device which drops a weight of about 130 g.

13. The window panel for a display device of claim 1, wherein another hard coating layer is on another side of the plastic substrate and comprising at least two continuously deposited layers.

14. A display device comprising the window panel according to claim 1.
